(19) United States
(12) Patent Application Publication
(10) Pub. No.: US 2020/0210759 A1
(43) Pub. Date: Jul. 2, 2020

(54) METHODS AND APPARATUS FOR SIMILAR DATA REUSE IN DATAFLOW PROCESSING SYSTEMS

(71) Applicant: Nanjing lluvatar CoreX Technology Co., Ltd. (DBA "lluvatar CoreX Inc. Nanjing"), Nanjing (CN)

(72) Inventors: Tien-Pei Chou, San Jose, CA (US); Po-Wei Chou, San Jose, CA (US); Ching-En Lee, San Jose, CA (US); Cheng Fu, San Jose, CA (US)

(73) Assignee: Nanjing Iluvatar CoreX Technology Co., Ltd. (DBA "Iluvatar CoreX Inc. Nanjing"), Nanjing (CN)

(21) Appl. No.: 16/237,102

(22) Filed: Dec. 31, 2018

(51) Int. Cl. G06K 9/62; G06N 20/10; G06N 5/04; G06N 3/08; G06T 1/20; G06F 9/38

(52) U.S. Cl. CPC G06K 9/6215; G06N 20/10; G06F 9/3893; G06N 3/08; G06T 1/20; G06N 5/04

(57) ABSTRACT

A computerized method identifies an input and kernel similarity in binarized neural network (BNN) across different applications as they are being processed by processors such as a GPU. The input and kernel similarity in BNN across different applications are analyzed to reduce computation redundancy to accelerate BNN inference. A computer-executable instructions stored thereon an on-chip arrangement receives a first data value for a data source for processing by the BNN at an inference phase. The computer-executable instructions further receives a second data value for the data source for processing by the BNN at the inference phase. The first data value is processed bitwise operations. A difference between the first data value and the second data value is calculated. The difference is stored in the on-chip arrangement. The computer-executable instructions applies the bitwise operations to the stored difference.

### TECHNICAL FIELD

The present invention relates to convolutional neural network acceleration.

### BACKGROUND

Convolutional Neural Networks (CNNs) are commonly used for image processing, object recognition, and video classification. A convolutional layer implements a set of kernels to detect features in the input image. A kernel may be defined by a set of weights Wand a bias term B. Each convolutional layer applies multiple kernels on the input where each kernel scans through the input in a sliding way, resulting in multiple output feature maps (ofmap). Unlike what happens in Fully-Connected (FC) layers, the weights of a kernel are shared across different locations on the input. Suppose the input vector is X and weight vector of a kernel is W, then the ofmap of this convolution operation is the dot product between them, added by the bias B, and followed by a non-linear activation function g( )as shown in Equation 1:

=g(W·X+B) (1)

In CNNs, a pooling layer is usually added after a convolutional layer. FC layers are often appended after several stacked convolutional blocks. During training, the ground-truth output serves as a supervision signal to learn parameters W and B by minimizing a loss function. After a CNN has been trained, the network inference is applied to the test image. Previous technology shows that the computation of the CNN inference is dominated by the convolution operation. However, lots of computation are actually not necessary because convolution is naturally a sliding-based operation.

Turning to binarized neural networks (BNN), recent studies have identified that there is no need to employ full-precision weights and activations since CNN is highly fault-tolerant. One may preserve the accuracy of a neural network using quantized fixed-point values, which is called quantized neural network (QNN). An extreme case of QNN is a BNN, which adopts weights and activations with only two possible values (e.g., −1 and+1). Prior binarization approach is called deterministic binarization, as illustrated in Equation 2. This approach is suitable for hardware accelerations.

x_{b}=Sign(x) (2)

Here, x can be any weight or activation input and x_{b} is its binarized version. It has been shown that input activation binarization causes much more degradation to the accuracy of BNN classification compared with weight binarization. Moreover, a BNN removes bitwidth redundancy in a classical CNN by using a single bit (−1/+1) for network parameters and intermediate representations. Such aspect greatly reduces the off-chip data transfer and storage overhead. However, a large amount of computation redundancy still exists in BNN inference.

As such, improvement over such shortcoming is desirable.

### SUMMARY

With understanding of weight sharing, aspects of the invention overcome prior approaches by reducing a computation cost of convolutions by exploiting what we have already computed so that we can reuse them instead of computing repeatedly. In addition, embodiments of the invention provide two BNN configurations: (i) both input and weights are binarized and (ii) Input is quantized to fixed-point values and weights are binarized. Aspects of the invention may focus on accelerating a BNN model on any BNN, which has convolution operations during inference phase.

Moreover, embodiments of the invention improve existing BNN by analyzing local properties of images and the learned BNN kernel weights. Based on the result of the analysis, aspects of the invention improve an average of about 78% input similarity and about 59% weight similarity among weight kernels, measured by metrics used network architectures as part of embodiments of the invention. Embodiments of the invention further reduce an amount of on-chip computations.

Furthermore, aspects of the invention create two types of fast and energy-efficient architectures for BNN inference. Additional embodiments further identify analysis and insights to pick a better strategy of these two for different datasets and network models. Embodiments of the invention reuse the results from previous computations so that much cycles for data buffer access and computations may be skipped. Through identifying BNN similarity, embodiments of the invention may demonstrate that about 80% of the computation and about 40% of the buffer access may be skipped. Such embodiments of the invention may achieve about 17% reduction in total power consumption, about 54% reduction in on-chip power consumption, and about 2.4× maximum speedup, compared to the baseline without applying embodiments of the invention. Alternative aspects of the invention further may be about 1.9× more area-efficiency compared to state-of-the-art BNN inference design. Moreover, such application of embodiments of the invention on FPGA may lead to a promising future of running deep learning models on mobile devices.

### BRIEF DESCRIPTION OF THE DRAWINGS

In order to more clearly describe the technical schemes in the specific embodiments of the present application or in the prior art, hereinafter, the accompanying drawings required to be used in the description of the specific embodiments or the prior art will be briefly introduced. Apparently, the drawings described below show some of the embodiments of present application, and for those skilled in the art, without expenditure of creative labor, other drawings may be derived on the basis of these accompanying drawings.

FIG. 1 is a diagram illustrating an input similarity and a kernel similarity according to the present application.

FIG. 2 is a diagram illustrating an input similarity computation according to an existing approach.

FIG. 3 is a diagram illustrating an input similarity computation according to one embodiment of the invention.

FIG. 4A is a graph illustrating an optimizing kernel weight reuse strategy according to one embodiment of the invention.

FIG. 4B is a diagram illustrating kernel weight reuse optimization algorithm according to one embodiment of the invention.

FIG. 5A is a diagram illustrating an input reuse accelerator according to one embodiment of the invention.

FIG. 5B is a diagram illustrating a weight reuse accelerator according to one embodiment of the invention.

FIG. 6 is a chart illustrating a performance of accelerators as a function of the input and kernel similarity according to one embodiment of the invention.

FIG. 7 is speedup of the input similarity accelerator across different layers for different types of applications according to one embodiment of the invention.

FIG. 8 is a chart illustrating speedup of using the weight re-order algorithm according to one embodiment of the invention.

FIG. 9 is a chart illustrating a percentage of reduced weight bank access across different convolution layers according to one embodiment of the invention.

FIG. 10 is a chart illustrating a percentage of reduced number of popcount across different convolution layers according to one embodiment of the invention.

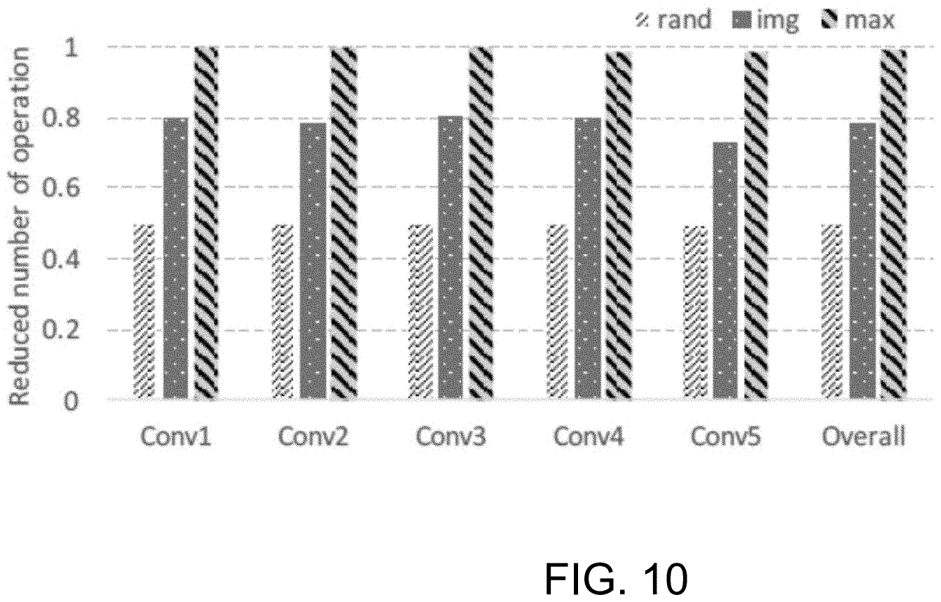

### DETAILED DESCRIPTION

Embodiments of the present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

In one embodiment, in describing acceleration of a BNN model on any BNN, which has convolution operations during inference phase, the input activation vector X of the BNN may be expressed as IA(h, w, c), corresponding to the horizontal index, vertical index, and channel index, respectively, throughout the disclosure. Such expression is meant to be exemplary and not as a limitation. Similarly, the weight vector W may be expressed as W(r, s, c, k), where corresponding to horizontal index, vertical index, channel index, and kernel index, respectively. Again, such expression is meant to be exemplary and not as a limitation.

In one embodiment, a thriving of Deep Neural Networks (DNN), especially Convolutional Neural Network (CNN), may be empowered by the advance of hardware accelerators, such as GPU, TPU, and neural network accelerators integrated into various embedded processors. The major challenges of accelerating classical CNNs, which are based on floating-point arithmetic, are (1) off-chip Dynamic Random-Access Memory (DRAM) access power overhead, and (2) on-chip data storage constraints. Many prior works have been proposed to accelerate CNNs by exploiting sparsity or leveraging data reuse. Among all kinds of solutions to the above challenges, quantization with reduced bitwidth in network parameters and input data is one of the most promising approaches. Some prior algorithms have successfully reduced the bitwidth of network weights while maintaining a high precision for image classification tasks. In particular, Binary Neural Network (BNN), a binary quantized version of CNN, has been studied extensively since it can significantly alleviate the DRAM memory access overhead and on-chip storage constraints. In BNN, the multiplication and addition in traditional floating point CNN inference are replaced by more power-efficient, compact, and faster bit operations, which are suitable for reconfigurable logic like Field-Programmable Gate Array (FPGA). However, though the bitwidth in both computation and storage has been considerably reduced, the total number of Multiplication and accumulation (MAC) operations still remains the same. For example, binarized VGG-16 neural network has reduced the network storage by around 5× but it still requires many computations (˜15.5 Giga MAC operations) to do inference on one input image.

In one embodiment of the invention, to reduce the number of MAC operations, embodiments of the invention leverage the key property of BNN: For example, as the input and kernel weights of BNN may be −1 or +1, the input and the kernel weights both exhibit high similarity. Intuitively, the input similarity may come from the spatial continuity of the image to classify, and the kernel similarity comes from the correlation of features represented by different binarized weight kernels. To further demonstration this property of BNN, aspects of the invention determine that the similarity of input and kernel across different applications and networks, as shown in Table 1:

TABLE 1
Input and kernel similarity ratio across different networks and datasets.
A = (8, 4) means 8-bit fixed point activation input including
4-bit fractional part. LeNet-5 and NIN are trained on XNOR-Net.

| | | Min Input | Avg Input | Max Input | Kernel |
|---|---|---|---|---|---|
| Dataset | Network | Sim (%) | Sim (%) | Sim(%) | Sim (%) |
| MNIST | LeNet-5 | 66.6 | 79.3 | 88.6 | 59.8 |
| MNIST | LeNet-5, | 10.6 | 37.5 | 67.0 | 59.8 |
| | A = (8, 4) | | | | |
| Citar-10 | BinaryNet | 59.6 | 78.6 | 957 | 50 |
| Citar-10 | BinaryNet, | 1.8 | 17.3 | 72.2 | 58.8 |
| | A = (8, 4) | | | | |
| Citar-10 | NIN | 51.3 | 83.9 | 977 | 64.5 |
| Citar-10 | NIN, A = | 2.7 | 23.5 | 66.7 | 543 |
| | (8, 4) | | | | |

In one embodiment, Table 1 may be a favorable setting in certain situations where the kernel similarity is much higher than input similarity. In other words, the degree of these similarities highly may depend on the dataset and the network architectures.

Based on these observations, embodiments of the invention provide an architecture of BNN accelerator that leverages input and kernel similarities to reduce the number of MAC operations at inference time. Instead of directly computing the XNOR between the input activation and kernel weights, aspects of the invention may first check the input or kernel weight difference between the current and previous computation stage, which focuses on different image regions or different weight kernels. Embodiments of the invention may reuse the results from the previous computation. As such, the data buffer access or MAC operations may be bypassed if there is no difference from the previous stage.

In one embodiment, aspects of the invention show that about 80% of the computation and about 40% of the buffer access on average may be skipped in this way. As a result, embodiments of the invention may reduce the total power consumption by about 17% and on-chip power consumption by about 54% in comparison to the one without using our reuse method. Aspects of the invention may also be 1.9× more area-efficient compared to the state-of-the-art BNN accelerator.

In addition, one embodiment, similarities may vary for different applications. Therefore, alternative embodiments of the invention provide analysis and insights to identify a better one from the proposed two reuse strategies for different datasets and network models.

Moreover, to realize a design that may efficiently accelerate BNN inference, an existing approach tend to optimize an objective called throughput which may be described by frame per second (FPS) as Equation 3:

$$F P S = \frac{\# Multipliers \times Utilization}{\# Ops\_per \_image} \qquad ( 3 )$$

where Utilization may indicate a ratio of time for multipliers doing inference over the total runtime. To increase the FPS, previous BNN works sought to increase the number of multipliers by reducing the control overhead. Other works exploit a highly parallelized computation architecture that can increase the Utilization. But another orthogonal direction for increasing the FPS is by reducing the number of Ops_per_image.

In one aspect, a large amount of computation redundancy exists in BNN inference. Thus, aspects of the invention may reduce the number of Ops_per_image by utilizing the input or kernel similarities which will be discussed below. Embodiments of the invention provide an advantage of reducing on-chip power consumption. Specifically, aspects of the invention save or store the data buffer access and computation power as a result of the reduced number of Ops_per_image.

### Similarity Inspired Reuse Strategy

In one example, in reducing the number of Ops_per_image to maximize the throughput, unlike floating-point values in CNNs, BNN has binarized weight and input after the model is trained. Thus, BNN may have only two values (−1/+1), which means one may have 50% chance of having the same value if a random two numbers in weight or input is picked.

In one embodiment, there may be an input similarity. An input similarity naturally exists in various datasets when we use BNN to classify images. Most natural images have spatial continuity and adjacent pixels are similar. In consequence, the binarized ofmaps may also very likely to be spatially similar.

In another embodiment, there may be a kernel similarity. A kernel similarity may come from the affinity of features represented by different binarized weight kernels. In one example, weight kernels of BNN are highly similar (only 42% are unique on Cifar-10). In this example, the kernel similarity may be further optimized by using the algorithm introduced below which may be computed off- line.

Based on these properties, an experiment on multiple BNN models was conducted to evaluate the input and kernel similarities which are defined as Equations 4 and 5 below:

IA(h, w, c)=IA(h, w−1, c), 0<w≤Wm (4)

W(r, s, c, k)=W(r, s, c, k −1), 0<k≤K (⁵)

The input or weight similarity ratio may be defined as the input or weight values that are subjected to Equation 4 and Equation 5 over the size of total input and weight values. The results are illustrated in Table 1. The reported kernel similarity is optimized by using the algorithm to be described below.

Referring to Table 1, the BNN has different average similarity ratio in both weight and input across different models. For BinaryNet, the average input and kernel similarity are about 78% and about 58% respectively, which may indicate a high computational redundancy in BNN inference and so does NIN on XNOR-Net. For BNN trained by XNOR-Net on MNIST, the average similarity ratio on input and weights may be about 79.3% and about 59.8%, respectively. In one aspect, many of the BNN models may be implemented with fixed-point input activations to maintain high classification accuracy. For BNN with fixed-point input and binarized weight, the input similarity may be much lower than kernel similarity as shown in Table 1. Therefore, which one is better or desirable varies case by case. The comparison and determination may be done off-line after the network and dataset are obtained.

Based on the insights generated by our experiment results, aspects of the invention develop two types of neural networks acceleration strategies which exploits either weight or input similarity to reduce redundant computations.

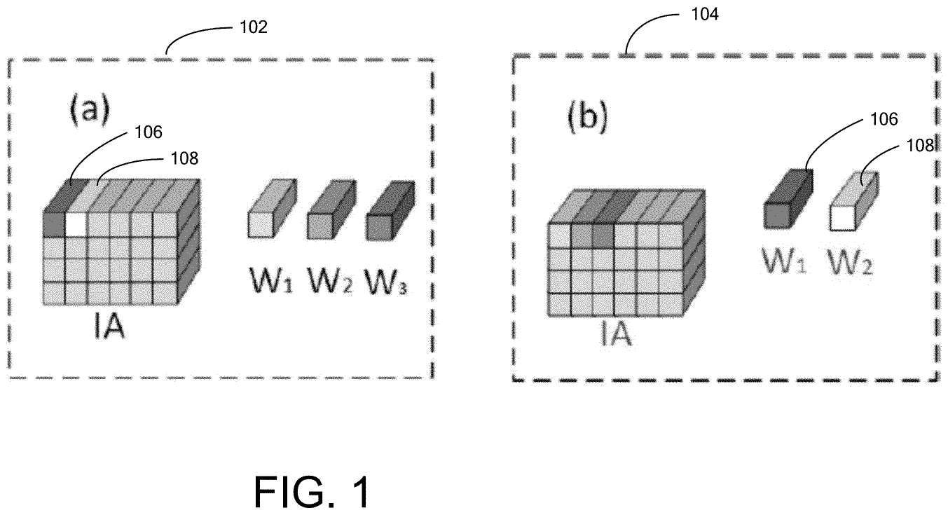

Referring now to FIGS. 1 through 3, a simple example is used to illustrate the idea of computation reuse. In one example, 102 illustrates an input similarity and 104 illustrates a kernel similarity in a given dot product convolution.

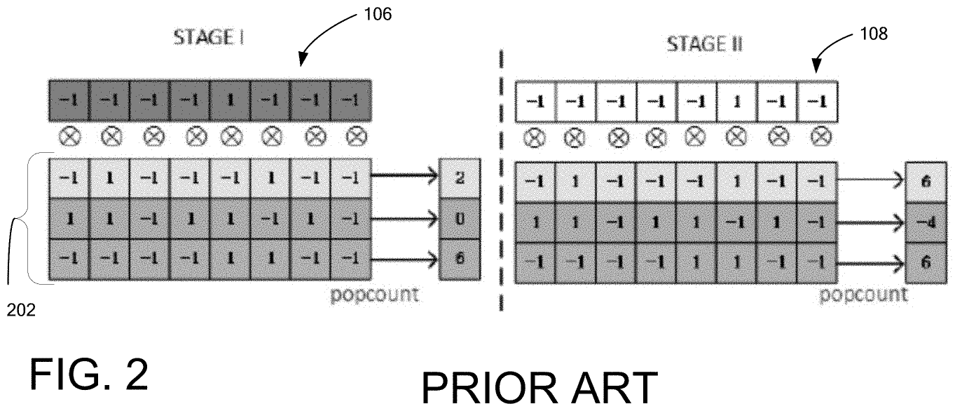

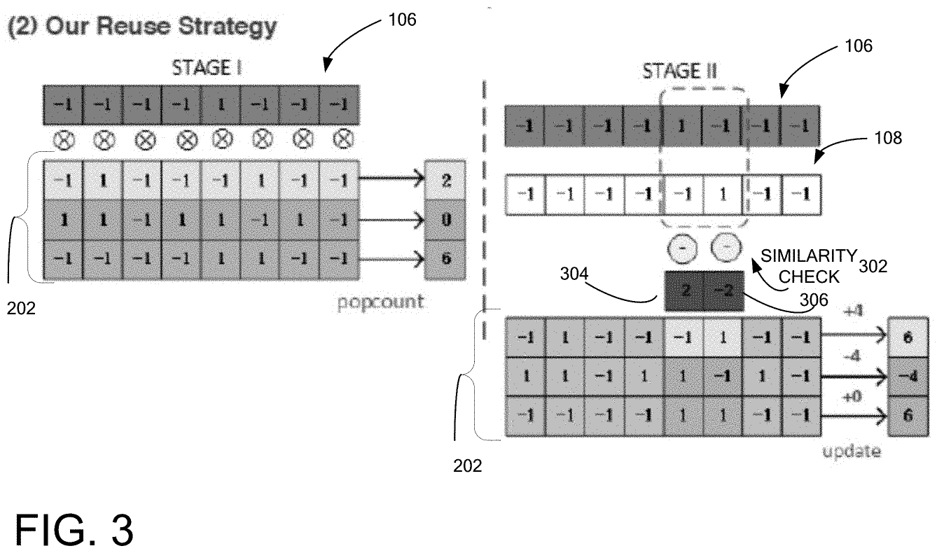

For example, CNN inference involves multiple dot products between input and kernels and they may computed in a sequential manner. The two stages shown in FIG. 2 represent two consecutive dot products (106 and 108) during convolution. As shown in FIG. 2, an existing approach to computing dot product between the input pixels and different 1×1 weight kernels is by doing bitwise XNOR 202 and then popcounts the resulted vector for accumulation for both STAGE I and STAGE II. With the computation reuse strategy in FIG. 3, an embodiment of the invention may still compute the result in the traditional fashion in STAGE I. In STAGE II, instead of computing the dot product again in the traditional way, embodiments of the invention save computations by updating the result from STAGE I by comparing a difference between the two dot products. This approach, in one embodiment, may be applied to leverage either input or kernel similarity. Note that while the examples in FIGS. 1-3 use 1×1 kernel, it is to be understood that they are merely for illustration purposes and are not meant to be limiting, such as to larger weight kernels using parallelism, e.g., 3×3 kernels used in our experiments below.

In another embodiment, such reuse strategy of aspects of the invention may be used in the input convolution. For example, in input Reuse: in one embodiment, assume the computation of STAGE I is finished in FIG. 3 (2). For the next dot product computation in STAGE II, aspects of the invention may first determine a difference, in a similarity check 302, between the current input (STAGE II) and the previous one (STAGE I) (e.g., 108 v. 106). In one embodiment, one may update the previous result from STAGE I based on this difference in STAGE II. In this way, the number of required bitwise operations 202 may be greatly reduced compared to the traditional way of computation if the inputs exhibit high similarity. In one embodiment, the computation of similarity may be done only once, compared with directly computing dot product repeatedly as seen in FIG. 2. Besides, only a small subset of weight, such as 304 and 306, need to be read out from on-chip memory.

In another embodiment, the reuse strategy may also be use in weight values. For example, different weight values at the same position of different kernels, e.g., weights at (r, s, c, ki) and (r, s, c, kj) (ki and kj denote the indices of two different kernels), may exhibit a high degree of similarity.

This similarity across different weight kernels may also be exploited in the similar way as the input reuse strategy. For the weight reuse strategy, in one embodiment, the process of reuse shares the same principle with the input reuse. As shown in 104 in FIG. 1, instead of computing the difference between input activations, we first check the difference between kernels and then update the previous dot product result accordingly.

Moreover, in another embodiment, the original computation order of the dot product between input and kernels may be further optimized off-line to achieve high degree of kernel similarity ratio.

For example, using the above reuse strategy, weight reuse may accelerate BNN inference reasonably. However, alternative embodiments of the invention may optimize weight reuse strategy to further accelerate the BNN inference. In one embodiment, optimization of the weight reuse may be done by re-ordering the convolution on kernels in each layer. In other words, the default computation order of kernels may not be optimal in further accelerating BNN interference.

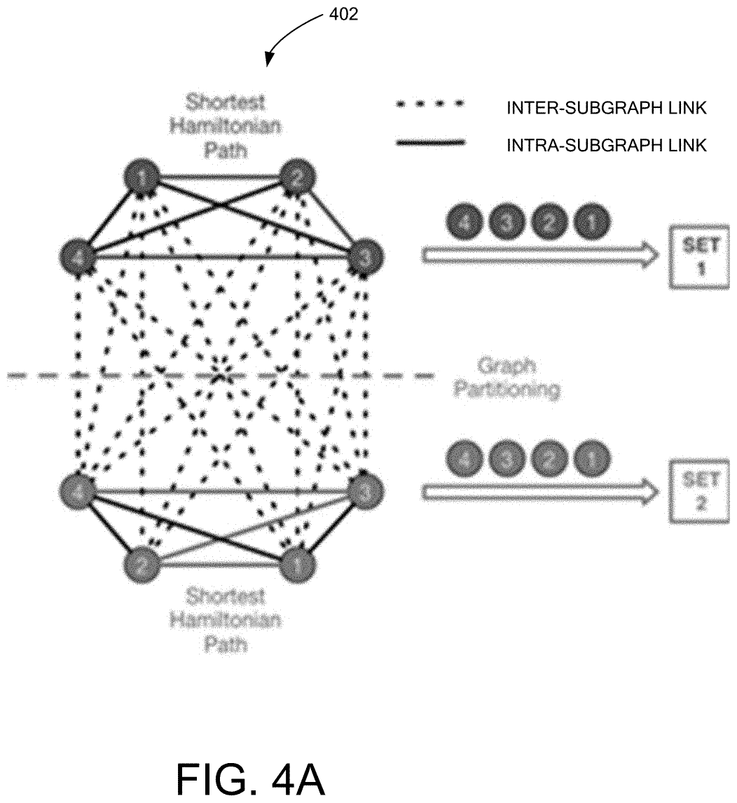

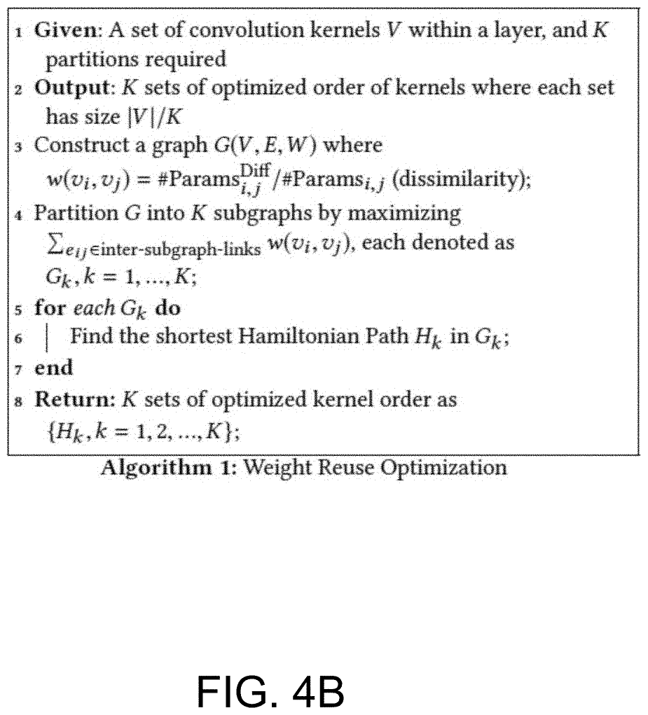

In one embodiment, an algorithm may identify a different or better order of convolutions using graph optimization. As shown in FIG. 4A, a graph G(V, E, W) 402 where each vertex v ∈ V corresponds to one kernel. Two vertices are connected by link e ∈ E with weight w ∈ W where w represents a degree of dissimilarity between two kernels.

In identifying an optimal order of convolutions, in one embodiment, one may search for the scheduling where the total dissimilarity is minimized, e.g., total similarity is maximized. In one embodiment, a graph partition may be performed. For example, the graph 402 may be first partitioned or divided into several subgraphs. The reason is that our proposed architecture has conditions on the number of kernels for reverting in each computation unit (i.e., Set 1 and 2 in FIG. 2). Suppose there we partitioned all the kernels into K subset, then each computation unit will work on |V |/K kernels. To partition the original graph into K subgraphs, for example, aspects of the invention maximize the summed weight of links in between subgraphs. For example, the dissimilarity in between group of kernels is maximized so that similarity is maximized within each group.

Moreover, at the sub-graph level, sub-graph optimization may be achieved. For example, for each subgraph containing |V|/K vertices, one may compute the shortest Hamiltonian path thus the accumulated dissimilarity is minimized along the path. FIG. 4A illustrates such an approach. In another example, a greedy approach may be used to solve Hamiltonian path problem in an efficient way because the graph can be very large if there exists a lot of kernels within a layer (e.g., 1024). In another embodiment, for a graph size that is relatively small, a non-greedy approach may be viable since this is optimized offline after BNN has been trained. The complete algorithm is shown in FIG. 4B.

In another example, after the above optimization, one may receive the optimized order of convolution in terms of kernel indices for each computation unit. With this kernel indices, an indexing map may be generated to be sent to the hardware (e.g., GPU) in order to process it. With this approach, in one embodiment, a condition on |V|/K to be 64 bit may be imposed to alleviate the hardware complexity and the overhead of the ofmaps reverting process.

### HARDWARE ARCHITECTURE

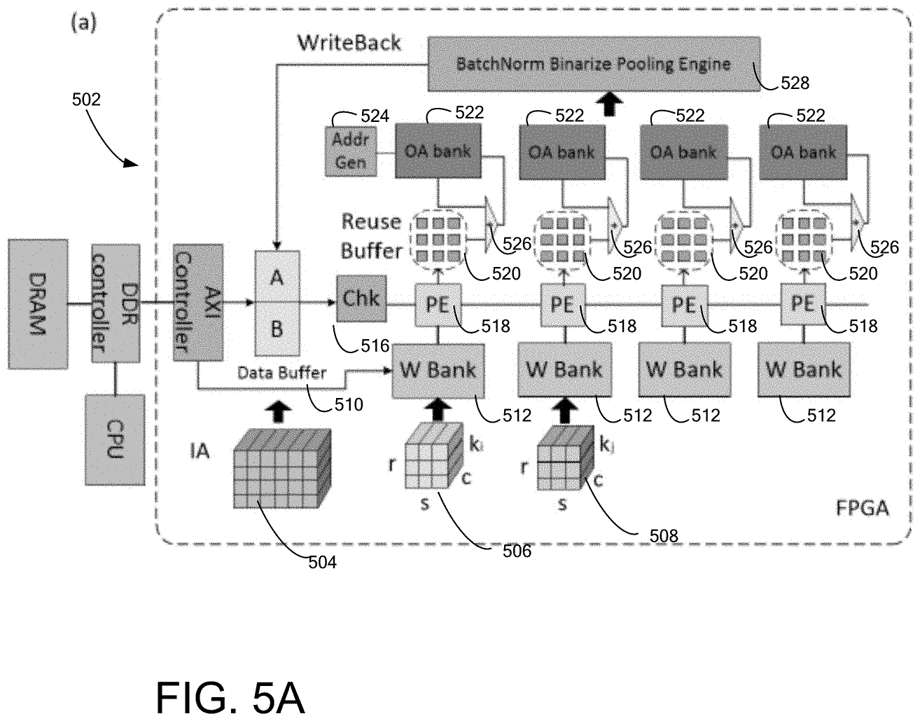

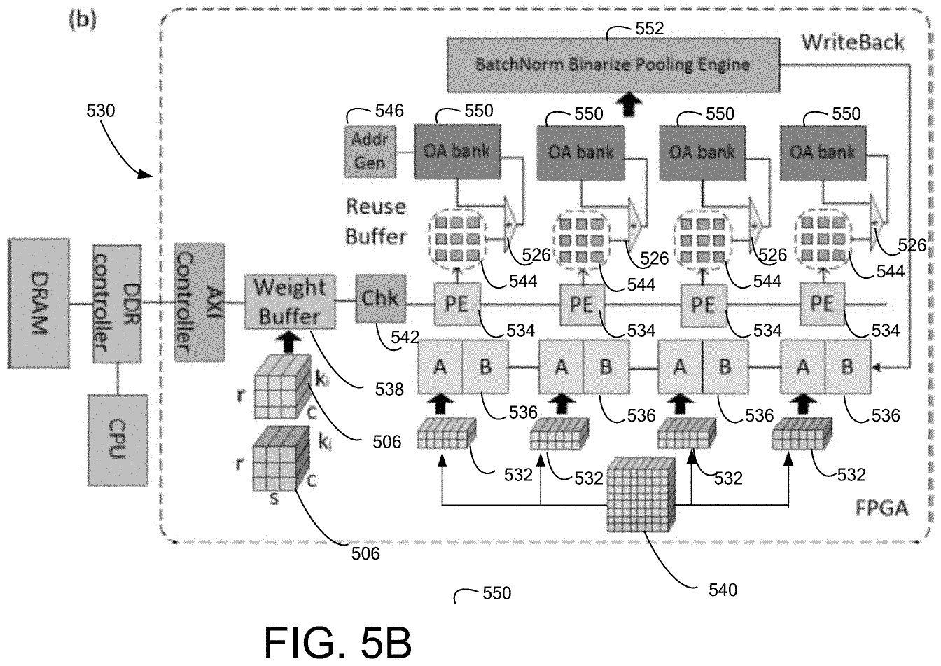

In one embodiment, aspects of the invention may be manifested in a hardware architecture that exploits the BNN similarity to save computations and memory accesses. Recall from the above that aspects of the invention introduce two types of reuse strategies, these strategies may be incorporated into two types of hardware accelerators that leverage input and kernel similarity, respectively. Referring now to FIG. 5A, a block diagram illustrating a design 502 of a computer architecture. In one example, the design 502 may be used as an input reuse accelerator. In this example, the design 502 provides the computer architecture with three stages of execution: data loading, computation, and accumulation. In one example, at the data loading stage, input 504 and weight data 506 and 508 may be read from off-chip memory and be stored into a data buffer 510 and/or weight memory banks (“WBank”) 512. In one embodiment, during the execution of a binarized convolution layer, the input data may be read from one data buffer and written to another equally sized buffer. In this example, the read or write mode of data buffer A and B in FIG. 5A may be switched for the computation of different layers so the input of each layer may not need to transfer back and forth between on-chip and off-chip memory.

During the computation stage, in one example, aspects of the invention may be described in a producer and consumer fashion. For example, the producer may a checking Engine (Chk) 516 which may be implemented as a bitwise C-by-C subtraction logic for checking the current input versus the previous one. In this example, for the computation of the first input during computation stage 506, which may corresponding to the STAGE I discussed in FIG. 3, the checking engine 516 may broadcast the original input value to Processing Elements (PE) 518 for computing a result in the traditional way by using XNOR and popcount. In one embodiment, for the rest of the input, aspects of the invention apply the reuse method for the computation stage, which may be consistent with STAGE II mentioned in FIG. 3. In this example, during the reuse computation, the checking engine 516 may subtract the current input with the previous one to check the difference. Once the checking is failed, the checking engine 516 may broadcast or output the subtraction result to all the processing elements 518 through a broadcasting bus. The processing elements 518 may read the weight out of the Wbank 512 and may scan the bus to find the different elements and update the reuse buffer which contains the result of last execution.

In one example, the different input values may be executed by n different processing elements 518 simultaneously. Each of the processing elements 518 may be assigned with a reuse buffer 520, a Wbank 512, and an Output Activation bank (OAbank) 522. In one embodiment, the storage of the weight value may be partitioned in kernel or k dimensions, so that the ofmaps result will not interleave across different OAbanks 522. Once the current pixel (e.g., difference) has finished broadcasting, the accumulation stage may begin. An address generator 524 and an accumulator 526, may collect the results in the reuse buffer 520 and accumulate them into the corresponding position of OAbank 522.

In one embodiment, the address generator 524 may calculate an destination address for different intermediate result in the reuse buffer 520. For example, one of the OAbank 522 may use an accumulation controller to collect the result in the reuse buffer 520 and may reduce them into the correct positions in the OAbank 522 indicated by the address generator 524. The address of the ofmap (h₀, w₀, c₀) (subscript₀ denotes output) of the given input locating at (h, w, c) and weight locating at (r, s, c, k) may be calculated as (h−r, w−s, k) or (h−r +1, w−s+1, k) if padding mode is enabled.

In one embodiment, a batch normalization engine 528 may be used. For example, once the computation of the current layer is finished, the batch normalization engine 528 may concatenate the ofmaps results from different OAbanks 522 and normalize the output by subtracting a normalization factor before binarizing the value into −1/+1. For example, aspects of the invention perform a batch normalization and pooling may be similar to previous BNN acceleration. In this example, batch-normalization and activation functions may be done together by comparing to the normalization factors across different ofmaps computed offline and then the pooling is done by using a lightweight Boolean AND operator. In this example, the entire batch normalization engine 528 in aspects of the invention provide the design 502 for the input similarity accelerator consumes 1541LUT and 432FF for a PE size of 8.

Referring now to FIG. 5B, a design 530 for a weight reuse accelerator is illustrated. For the weight reuse accelerator, the design 530 may be similar to the design 502 for the input reuse accelerator. For example, as is shown in FIG. 5B, different lines of the input activation (IA) 540 will be evenly distributed as 532 across PEs 534 instead of different weight kernels (e.g., Wbanks 512) for the design 502 of the input reuse accelerators. In this design 530, two equally-sized buffers 536 may be assigned to each PE 534. The IA data from the IA 540 may be read from and written into two separate buffers 536 as the design 502 illustrated for the input reuse accelerator. In another example, instead of broadcasting the input difference to PE 534 like the design 502 for the input reuse accelerator, weight reuse accelerator broadcasts the difference between the weight kernels to PE 534.

In one example, in one embodiment, the weights may be pre-processed off-line by using the algorithm introduced in FIG. 4B to reorder the weight kernels with different k dimensions to produce similarity. In this example, the hardware may allow the weight kernel to be executed out-of-order in a given re-ordering range as aspects of the invention may revert the sequence of the ofmaps on-chip. Larger reordering range may be achieved even higher degrees of similarity among weight kernels but also may be introduced higher ofmap reverting overhead. The sequence information of the permuted weight kernels may be loaded on-chip for reverting the ofmaps. But overall, assuming the reordering range is 64 bit, the sequence information overhead may 10K bits which is less than 0.2% of the size of the weight kernels and thus may be ignored.

In one embodiment, aspects of the invention replace the representation of −1/+1 in weight kernel with “same” (0) and “different” (1), except for the first dot product computation. In this example, the on-chip checking process may bypass the subtraction logic. Once the computation stage begins, the weights may be loaded into a weight buffer 538 and the input activation will be distributed to the IA buffers 536 on-chip. A checking engine 542 may not need to do subtraction as the weights have been pre-processed off-line in the representation of in “different” (1) versus “same” (0). The first weight kernel to be computed may use the original value with XNOR and popcount for accumulation. In one embodiment, it may be stored in the checking engine 542 as a weight base which will be continuously updated during the checking process. In this example, the weight base may keep the latest version of the real weight value to recover the weight difference during the computation. For the rest of the computations, aspects of the invention may begin to use the weight reuse strategy for computation. The check engine 542 may scan the weight value to check for the similarity. Once the similarity check fails in the computation, the check engine 542 may generate the weight difference based on the weight base vector and broadcast the weight difference to all the PEs 534 where different lines of the input activation are stored in reuse buffers 544. In one embodiment, the check engine 542 may update the weight base which may be the real weight data used for the following computation.

An address generator 546 may calculate a uniform address for PE 534 reduction once a weight kernel finishes broadcasting. As the input is not duplicated in different IA buffer, some results in OAbank 548 may be partial sums which may need to be further reduced in the last stage before the batch normalization and pooling. In one embodiment, a final batch normalization engine 552 may finish the last reduction before the batch normalization and ofmap reverting process. In one example, the final result may be stored back into the data buffer 536 once the execution is finished. In one embodiment, the design 530 of the weight reuse acceleration may be a symmetric version of the design 502 for the input reuse accelerator where we exploit kernel similarity across the difference. The differences between the two designs 502 and 530 for the input reuse accelerator and the weight reuse accelerator, respectively, may be mainly in the reduction and reverting logic. It is to be understood that additional features may be built upon the designs 502 and 530 of embodiments of the invention without departing from the scope or spirit of embodiments of the invention.

In one aspect, embodiments of the invention may be applied to a real FPGA board. The following illustrates exemplary results and they appear to show increased performance by using embodiments of the invention compared with benchmark BNN model in terms of speed and energy efficiency.

To further evaluate the designs as described according to embodiments of the invention, aspects of the invention are implemented to two types of BNN inference accelerators which may be suitable to exploit input and weight reuse strategies respectively for convolutional layers (cony). The process of decision-making between input or weight reuse strategy may depend on the performance of the two types of accelerators on a given model. In this example, a test of the designs on the BinaryNet—an inference model for CIFAR-10 (32×32 color images) classification—was performed. In this test, the pre-trained BinaryNet neural network was from an open-source code. The summary of the workload is listed in Table 2 below:

TABLE 2

| | | | | graph |
|---|---|---|---|---|
| | | | weight | partition |
| | input dim | weight dim. | size | parameters |
| layer | (h, w) | (r, s, c, k) | (Bits) | (V, K) |
| conv1 | 32, 32 | 3, 3, 128, 128 | 144K | 64, 2 |
| pool | 32, 32 | — | — | — |
| conv2 | 16, 16 | 3, 3, 128, 256 | 288K | 64, 4 |
| conv3 | 16, 16 | 3, 3, 256, 256 | 576K | 64, 4 |
| pool | 16, 16 | — | — | — |
| conv4 | 8, 8 | 3, 3, 256, 512 | 1.1M | 64, 8 |
| conv5 | 8, 8 | 3, 3, 512, 512 | 2.3M | 64, 8 |
| pool | 8, 8 | — | — | — |

In this test, the BinaryNet for CIFAR-10 model may achieve about 11.19% testing error. Our design may also be used to accelerate BNN models other than BinaryNet with arbitrary weight kernel size. In this test, a prototype is implemented by using a high-level synthesize tool, such as Xilinx SDx 2018.1. The accelerated functions are written in high-level programming language. The SDx synthesize tool may automatically generate essential AXI bus for memory communication between off-chip memory and FPGA. In this example, the SDx tool also synthesizes the marked function into RTL and bitstream. During the inference, the CPU awakes the FPGA acceleration once the hardware function is called.

In this test, aspects of the invention may be implemented on a circuit board, such as Xilinx Zynq ZCU104 board containing a microprocessor, such as an ARM Cortex-A53 processor with a target clock frequency of 200 MHz. As embodiments of the invention may be scalable in the number of PEs, it is configured in this test for a design with 8 PEs in the following experiments.

### Performance Analysis

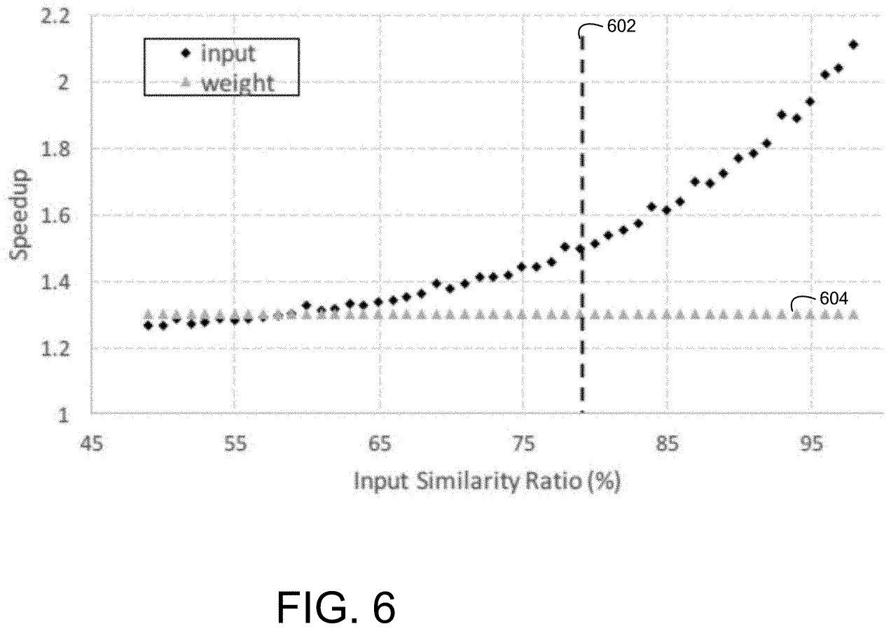

As previously discussed, embodiments of the invention may identify input similarity from input activations and, based on the input similarity, critical analysis is performed. In highlighting the two types of strategic approaches illustrated above, in determining how aspects of the invention may dynamically determine or choose between the input and the weight reuse accelerator, the influence of input similarity ratio on the performance of the two designs may be evaluated as part of the test. FIG. 6 is a chart illustrating a performance of accelerators as a function of the input and kernel similarity. In one example, FIG. 6 may represent the speedup of accelerators as a function of the input similarity ratio defined in the improved weight reuse optimization above. In FIG. 6, a vertical dash line 602 in the chart or graph indicates the average input image similarity among the testing dataset. A baseline 604 may be the runtime of input reuse accelerator without using the reuse technique. In one example, the input reuse accelerator may provide a variable speedup which may depend on the similarity ratio of the input application. However, according to aspects of the invention, the weight reuse accelerator may provide a stable speedup which is based on the similarity ratio between weight kernels after re-ordering. As is shown by the vertical dash line in FIG. 6, the speedup at a point of average input similarities of the input applications which may be corresponding to the third row of Table 1, input reuse strategy may provide a better performance compared to weight reuse. As such, aspects of the invention enable a conclusion, based on the test and what's shown in FIG. 6, that for CIFAR-10 model, input reuse accelerator may provide a better performance and such application in this BNN architecture is desirable. For BNN models with fixed-point input activations, as is shown in the “1” where the input is fixed-point value, the similarity ratio for input is low and the decision-making process may prefer weight reuse strategy in such case. The analysis for BNN models that focus on weight reuse may be left for future development without departing from the scope or spirit of embodiments of the invention.

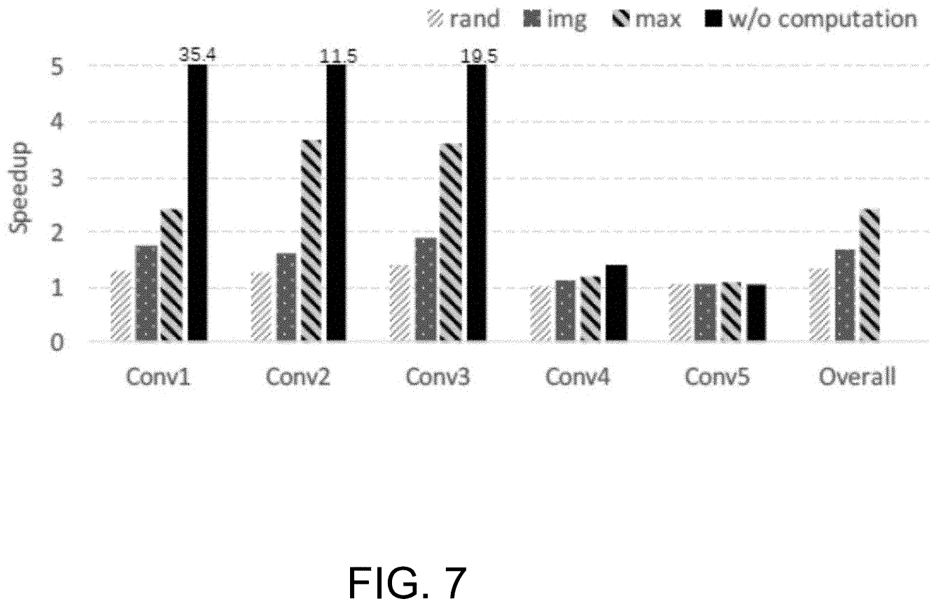

In one aspect of the invention, the performance of the input accelerator for different types of applications may be analyzed. For example, referring now to FIG. 7, is a graph illustrating a speedup of the input similarity accelerator across different layers for different types of applications according to one embodiment of the invention. In one example, “rand” may indicate the input image is random (−11+1) series; “img” may denote the average performance of the testing images from CIFAR-10 testing dataset; “max” may denote the tested when all the pixels of the input image is in the same color, i.e., all the pixels in the classified input image are the same, and “w/o computation” may denote a runtime restricted by off-chip data transfer and CPU control overhead. For example, FIG. 7 may show the effect of these input applications versus speedup. For conv4 and conv5 (where cony is an abbreviation for convolution), the speedup of exploiting the input similarity is small and this may be due to that the input activation size is small and weight size is large. It is expected to see the bottleneck in these layers is in the off-chip memory bandwidth.

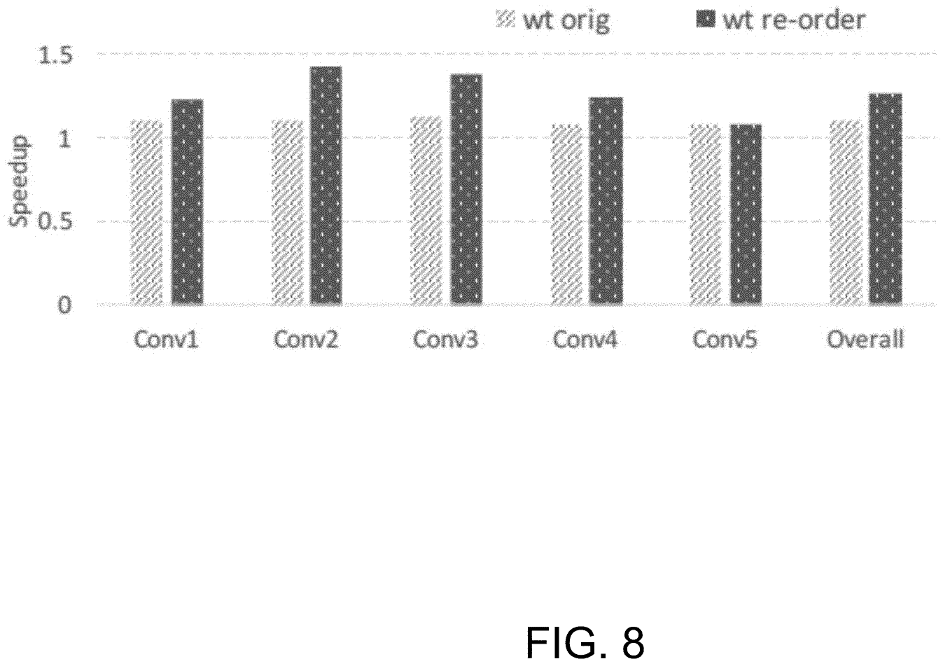

In terms of the speedup by weight reuse, it is noted that the similarity ratio of kernel similarity cannot bring too much gain in the speedup. The detail of the speedup of weight re-ordering algorithm is shown in FIG. 8. In this example, “wt orig” may denote the performance of original weight order and ‘wt re-order’ represents the performance of the acceleration applied with off-line reordered algorithm. By utilizing the re-ordering strategy, the inference can achieve 1.26× speedup on average.

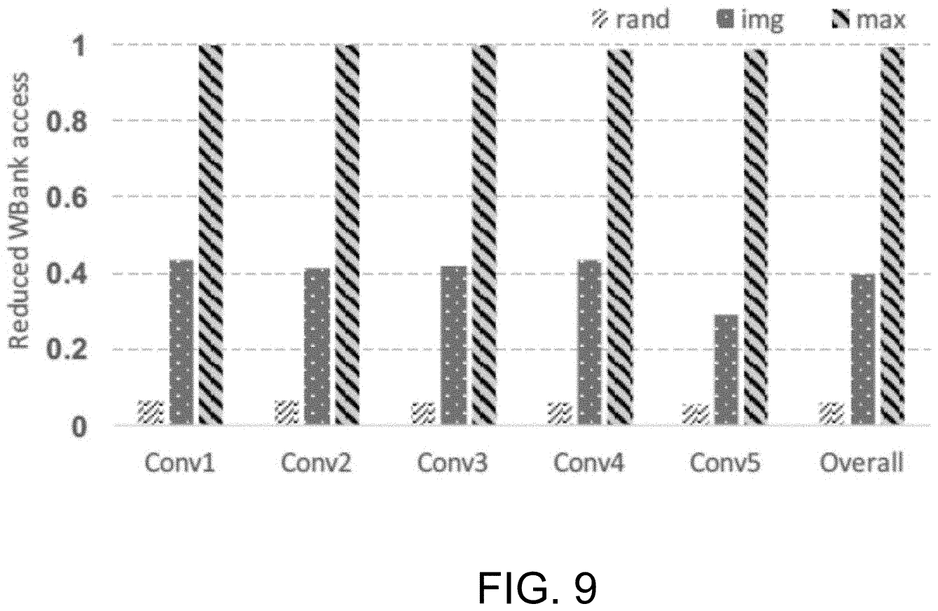

To show the reduction in weight buffer access and the total number of operations by exploiting the BNN reuse technique, embodiments of the invention further examine a reduction of weight buffer access and bitwise operations as is shown in FIG. 9. A baseline is the weight buffer access and bit operations without using the input reuse technique. As the size of weights on-chip dominates the input activation size, in this example, only the weight bank access in this experiment is used to approximate the total data buffer access in this analysis. Embodiments of the invention identify that on average, the input reuse technique may weight bank access by about 40% and bitwise operations by about 80% for the testing images, which may lead to reduction in on-chip power consumption. The accelerator may bypass almost all the weight bank access and bitwise operations if the input application exhibits maximal similarity.

Embodiments of the invention identify a high proportion of on-chip computation redundancy in BNN inference. And this property may be leveraged to reduce the on-chip power consumption and further accelerate the inference of BNN.

Moreover, to further analyze the power savings in our accelerator, embodiments of the invention measure effectiveness of the power consumption at the socket using a power monitor. The power consumption of programmable logic may be calculated by subtracting the power measured while BNN is running with the power measured at idle stage. The measured results may be averaged over a period of time while the accelerator is doing required inference.

TABLE 3

| | w/o reuse | w/o compute | img | max |
|---|---|---|---|---|
| Power (W) | 0.36 | 0.21 | 0.30 | 0.23 |

Table 3, in one example, may illustrate the power consumption of the programmable logic when FPGA is inferencing three different types of applications as part of the power analysis. In this analysis shown in Table 3, a comparison column showing power consumption of data transfer without any on-chip computation. In one example, the input reuse strategy on average may reduce the total power consumption by about 17% and on-chip power consumption by about 54% compared to the baseline accelerator without exploiting the similarity reuse technique.

In addition, aspects of the invention are also compared with the state-of-the-art BNN design as shown in Table 4 below.

TABLE 4

| | FPGA ’16 01 | FPGA ’16 02 | FPGA’17 | EMBODIMENT PE8 | EMBODIMENT PE16 |
|---|---|---|---|---|---|
| board | [symbol] | [symbol] | [symbol] | [symbol] | [symbol] |
| clock(MHz) | 150 | 120 | 147 | 200 | 200 |
| precision (bit) | 8-16 | 16 | 1-2 | 1-2 | 1-2 |
| kLUTs | 183 | 120* | 46.9 | 45 | 72 |
| FF | 128K | no report | 46K | 13K | 19K |
| DSPs | 780 | 760* | 3 | 5 | 1 |
| BRAM | 486 | 1377 | 94 | 112 | 1 |
| GOPS (conv) | 187.8 | 136.5 | 318.9 | [symbol] | [symbol] |
| GOPS/kLUT | 1.46 | 1.14 | 6.79 | 9.14 | 12.74 |

[symbol]

indicates data missing or illegible when filed

As embodiments of the invention have illustrated based on light-weight architecture for BNN acceleration, for example, aspects of the invention may choose a baseline with similar resource consumption for comparison and both of the computer/hardware architectures for single-bit input and weight. In addition, embodiments of the invention further compare results with floating point CNN accelerator (FPGA'16 01) and (FPGA'16 02) in Table 4. In one embodiment and as discussed above, aspects of the invention may be scalable with configurable number of PE. With a large amount of PEs, the on-chip computation will mostly be restricted by the memory bandwidth, the average giga-operations-per-second (GOPS) for testing image becomes closer to the “max” GOPS when scaling the PE size to 16. As shown in Table 4, embodiments of the invention demonstrate result with PE size of 8 and 16 achieving the 9.14 and 12.74 GOPS/kLUT. Such results are about 1.34 times and about 1.87, respectively, times more area-efficient compared to the baseline.

In summary, aspects of the invention provide a new FPGA-based BNN acceleration scheme, which incorporates both algorithm and hardware architecture design principles. The designs of embodiments of the invention, for example, may reduce latency and power consumption of BNNs by exploiting input and kernel similarities. In another embodiment, aspects of the invention have demonstrated that BNN inference has the property of high ratio of similarity in both input and kernel weights. The similarity of the input image comes from the spatial continuity between input pixels. Kernel similarity may be enhanced by applying to a proposed reordering algorithm. With different fixed-point representation for BNN input activation, either input or weight exhibits higher similarity ratio which may be exploited to reduce the bit operations and buffer access. By leveraging these two properties of the BNN, embodiments of the invention provide two types of accelerators, which may be applied to different situations. Insights generated by comparing these two accelerators to assist strategy selection and combination have been provided in various examples of the invention. Moreover, experiments conducted show that the power and speed of BNN inference may be largely improved through reducing computation redundancy. In one alternative embodiment, deploying approaches as discussed may be suitable for neural networks deployed to real-time applications.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A computerized method for reducing a number of MAC operations at interference time comprising:
receiving a first input data for an input image for processing by a binarized neural network(BNN) at an inference phase;
receiving a second input data for the input image for processing by the BNN at the inference phase;
processing the first input data using bitwise operations;
calculating a difference between the first input data and the second input data;
storing the difference in an on-chip arrangement; and
applying the bitwise operations to the stored difference.

2. The computerized method of claim 1, wherein processing the first input data comprises processing the first input data using a graphical processing unit (GPU).

3. The computerized method of claim 1, further comprising:
detecting features in the input image using a set of kernels in a convolutional layer;
receiving a first kernel weight for one of the kernels;
receiving a second kernel weight for another of the kernels;
processing the first kernel weight using bitwise operations;
calculating a difference between the first kernel weight and the second kernel weight;
storing a kernel difference in an on-chip arrangement; and
applying the bitwise operations to the stored kernel difference.

4. The computerized method of claim 3, further comprising constructing a graph for the kernels, said graph being expressed as G(V, E, W), where each vertex v ∈ V corresponds to one of the kernels, two vertices being connected by link e ∈ E with a weight w ∈ W representing a degree of dissimilarity between two of the kernels.

5. The computerized method of claim 4, further comprising partitioning the graph.

6. The computerized method of claim 5, wherein partitioning the graph comprises partitioning the graph into subgraphs based a summed weight of links in between the subgraphs.

7. A computerized method for reducing a number of MAC operations at interference time comprising:
receiving a first data value for a data source for processing by a binarized neural network(BNN) at an inference phase;
receiving a second data value for the data source for processing by the BNN at the inference phase;
processing the first data value using bitwise operations;
calculating a difference between the first data value and the second data value;
storing the difference in an on-chip arrangement; and
applying the bitwise operations to the stored difference.

8. The computerized method of claim 7, wherein processing the first input data comprises processing the first input data using a graphical processing unit (GPU).

9. The computerized method of claim 7, wherein the data source comprises an input image, wherein the first data value comprises a first input data of the input image and wherein the second data value comprises a second input data of the input image.

10. The computerized method of claim 9, wherein the data source comprises a set of kernels used in a convolutional layer for detecting features of the input image, wherein the first data value comprises a first kernel weight, and wherein the second data value comprises a second kernel weight.

11. The computerized method of claim 10, further comprising constructing a graph for the kernels, said graph being expressed as G(V, E, W), where each vertex v ∈ V corresponds to one of the kernels, two vertices being connected by link e ∈ E with a weight w ∈ W representing a degree of dissimilarity between two of the kernels.

12. The computerized method of claim 11, further comprising partitioning the graph.

13. The computerized method of claim 11, wherein partitioning the graph comprises partitioning the graph into subgraphs based a summed weight of links in between the subgraphs.

14. A computer-executable instructions stored thereon an on-chip arrangement for reducing a number of MAC operations at interference time comprising:
receiving a first data value for a data source for processing by a binarized neural network(BNN) at an inference phase;
receiving a second data value for the data source for processing by the BNN at the inference phase;
processing the first data value using bitwise operations;
calculating a difference between the first data value and the second data value;
storing the difference in the on-chip arrangement; and
applying the bitwise operations to the stored difference.

15. The computer-executable instructions of claim 14, wherein processing the first input data comprises processing the first input data using a graphical processing unit (GPU).

16. The computer-executable instructions of claim 7, wherein the data source comprises an input image, wherein the first data value comprises a first input data of the input image and wherein the second data value comprises a second input data of the input image.

17. The computer-executable instructions of claim 9, wherein the data source comprises a set of kernels used in a convolutional layer for detecting features of the input image, wherein the first data value comprises a first kernel weight, and wherein the second data value comprises a second kernel weight.

18. The computer-executable instructions of claim 10, further comprising constructing a graph for the kernels, said graph being expressed as G(V, E, W), where each vertex v ∈ V corresponds to one of the kernels, two vertices being connected by link e ∈ E with a weight w ∈ W representing a degree of dissimilarity between two of the kernels.

19. The computer-executable instructions claim 11, further comprising partitioning the graph.

20. The computer-executable instructions of claim 11, wherein partitioning the graph comprises partitioning the graph into subgraphs based a summed weight of links in between the subgraphs.
